(19) United States
(12) Patent Application Publication
(10) Pub. No.: US 2026/0172638 A1
(43) Pub. Date: Jun. 18, 2026

(54) Interactive Platform for Collaborative Music Battles and Shared Creative Experiences

(71) Applicant: Edward Clark, Decatur, GA (US)

(72) Inventor: Edward Clark, Decatur, GA (US)

(21) Appl. No.: 18/983,437

(22) Filed: Dec. 17, 2024

(51) Int. Cl. H04N 21/4788; H04N 21/431; H04N 21/466

(52) U.S. Cl. CPC H04N 21/4788; H04N 21/4316; H04N 21/4666

(57) ABSTRACT

The invention is an interactive platform designed to foster collaborative and gamified experiences through music-based activities, trivia challenges, and shared creative sessions. The system integrates real-time synchronization, AI-powered optimization via external APIs (e.g., OpenAI's ChatGPT API) for song pairing and trivia generation, and a secure cloud-based infrastructure to deliver engaging user experiences. Users can participate in music battles with AI-optimized song selections, compete in trivia, and engage in creative activities. The platform incorporates a Family Circle feature, enabling private and invitation-only group participation, and leverages integration with third-party APIs such as Apple Music for seamless media playback. Gamification elements, including leaderboards powered by Apple Game Center and real-time voting, enhance engagement, while dynamic scheduling and notifications ensure streamlined participation. By combining entertainment, education, and social interaction, the invention addresses the need for meaningful digital engagement, offering versatile applications for family bonding, music education, team-building, and virtual events.

### BACKGROUND OF THE INVENTION

### Field of Invention

The present invention relates generally to interactive entertainment platforms and, more specifically, to a system and method for enabling collaborative, gamified experiences through music-based activities, trivia, and shared creative sessions. This invention pertains to the fields of digital entertainment, social interaction technologies, music education, and artificial intelligence (AI)-driven content personalization. The invention is further applicable to real-time collaborative tools utilizing synchronized multimedia playback and gamified social engagement, integrating cloud-based infrastructure and advanced AI algorithms for dynamic user experiences.

### BRIEF SUMMARY OF THE INVENTION

The invention is a novel interactive platform designed to create meaningful connections through music battles, trivia challenges, and collaborative creative experiences. The system facilitates both real-time and asynchronous engagement, combining gamified activities with advanced integrations to deliver personalized and dynamic user experiences.

Key features include:

Music Battles with Real-Time Voting: Participants compete in synchronized music battles, leveraging real-time playback and instant voting mechanisms to ensure seamless interaction.

AI-Enhanced Features: The platform utilizes OpenAI's ChatGPT API to provide optimized song pairings and adaptive trivia questions, tailored to the context of the battle or session. Additional user-configurable preferences allow filtering of songs by production role, such as “featured by,” “performed by,” or “produced by” the selected artist.

Third-Party API Integration: Integration with Apple Music ensures access to a vast library of content and smooth playback, enhancing the user experience.

Leaderboards via Game Center: The platform leverages Apple's native Game Center interface to track user performance and encourage friendly competition.

Additional functionalities include a private Family Circle system for controlled and secure social interactions, as well as dynamic scheduling tools for planning events. The platform is designed to support various use cases, including family bonding, virtual team-building, and casual entertainment.

By blending entertainment, collaboration, and personalization, the invention redefines digital social engagement, offering an inclusive and interactive environment for users of all ages and technical skill levels.

### BRIEF DESCRIPTION OF THE FIGURES

FIG. 1: illustrates the user journey on the platform, from account creation and activity setup to AI-powered personalization, real-time engagement, and post-session analytics.

### DETAILED DESCRIPTION

The invention is an advanced interactive platform designed to foster meaningful connections and enhance creative collaboration through music battles, trivia games, and other shared creative experiences. The platform combines cutting-edge technologies such as real-time synchronization, AI-enhanced features provided by OpenAI's ChatGPT API for content curation, and scalable cloud-based infrastructure to deliver an engaging, seamless, and personalized user experience. It serves as a dynamic hub for individuals and groups to participate in gamified, music-driven activities, enabling real-time and asynchronous interactions that transcend physical boundaries.

At its core, the platform facilitates music battles, where users select tracks, compete head-to-head or song-by-song, and vote on their favorites in real-time. These battles are customizable, allowing themes such as specific decades, genres, or artist-specific showdowns. To enhance engagement, the platform integrates AI-enhanced song pairing using OpenAI's ChatGPT API, which allows filtering and selection based on user-defined criteria, such as songs featured by, performed by, or produced by specific artists. This creates a cohesive and balanced competitive atmosphere, tailored to the preferences and skill levels of the participants. Additionally, the platform introduces trivia challenges seamlessly into the battles, providing participants with questions related to the music, artists, or genres being featured. Trivia questions are generated dynamically via OpenAI's ChatGPT API, ensuring they are fresh, contextually relevant, and aligned with the music or themes in the session, offering both entertainment and educational value.

The platform also employs AI-enhanced content personalization powered by OpenAI's ChatGPT API, providing recommendations based on user preferences and filtering criteria for curated trivia and optimized song pairings. The AI leverages integration with external APIs, such as Apple Music, to pull data on user libraries, playlists, and listening habits, enriching the customization and depth of the interactive activities.

To ensure secure and private engagement, the invention incorporates a Family Circle feature. This system allows users to create private groups, restricting participation to explicitly invited members. The invitation process is streamlined through integration with Apple's Contact API, enabling users to select participants from their existing contacts seamlessly. The Family Circle concept emphasizes controlled social engagement, fostering a safe and trusted environment for collaborative activities. This feature is particularly valuable for family gatherings, team-building exercises, and other intimate settings where privacy is a priority.

Real-time synchronization is a foundational aspect of the platform, achieved through technologies such as SharePlay. This ensures that all participants experience synchronized music playback, voting, chat, and trivia interactions regardless of their physical location. The system updates session states in real-time, providing instant feedback and ensuring smooth transitions between activities. Gamification elements are seamlessly embedded throughout the platform, with a leaderboard powered by Apple's Game Center that tracks performance for challengers and spectators alike. This leaderboard not only fosters competition but also encourages continued engagement by rewarding active participation and skillful performance.

The platform's technical architecture leverages a robust cloud-based infrastructure to support its diverse functionalities. Data such as user profiles, song lists, voting history, and Family Circle memberships are stored in a secure, scalable database (e.g., AWS DynamoDB). This architecture ensures fast and reliable access to data across devices. The system employs serverless backend processing with AWS Lambda to handle data retrieval, voting calculations, and AI content generation, ensuring low latency and high scalability. To further enhance user convenience, the platform integrates scheduling tools that allow users to plan, reschedule, and join events. Notifications and calendar sync features are included to keep participants informed and organized.

The platform's user interface (UI) is designed with an intuitive and adaptive approach to accommodate participants of all ages and technical skill levels. It provides a centralized dashboard where users can access ongoing battles, upcoming events, and creative sessions. Dedicated setup screens guide users through the process of configuring traditional or AI-generated battles, managing playlists, and customizing session parameters. During active sessions, users can interact through a real-time chat overlay, respond to trivia, and vote on music selections, all displayed through a visually appealing and responsive interface.

Integration with third-party APIs such as Apple Music is a critical feature, allowing users to access vast music libraries, create custom playlists, and synchronize media playback. The platform also supports advanced media controls, enabling users to adjust playback, skip tracks, or replay specific sections of songs. AI-enhanced features, including trivia generation and song filtering, rely on OpenAI's ChatGPT API to ensure a continually fresh and engaging experience.

The invention supports a variety of use cases, making it adaptable to different settings and audiences. Families can use the platform for bonding through music battles during gatherings, while remote groups can connect and interact in real-time via virtual listening sessions. Music educators can incorporate the platform into their teaching to engage students with interactive trivia and curated battles focusing on specific genres or music history. Additionally, corporations can use the system for team-building exercises, leveraging its collaborative and gamified features to foster creativity and strengthen team dynamics.

Overall, the platform represents a significant advancement in digital entertainment and social interaction technologies. By integrating real-time collaboration, AI-driven personalization, gamification, and secure social engagement, the invention addresses the growing demand for meaningful and interactive online experiences. It combines entertainment, education, and connection in a unified system, making it a versatile and innovative solution for individuals, families, educators, and businesses alike.

Below is a sample of the AI code that will be implemented in Swift for the core AI functionalities of the platform, such as personalized song pairing, trivia question generation, and recommendation optimization.

```
  class SongCacheManager {
    func retrieveSongs(for battle: MusicBattle, completion: @escaping ([[AISong]]) −
> Void) {
      // Placeholder for API endpoint
      guard let url = URL(string: “API_ENDPOINT”) else { return }
      var request = URLRequest(url: url)
      request.httpMethod = “POST”
      request.addValue(“application/json”, forHTTPHeaderField: “Content-Type”)
      let requestBody: [String: Any] = [
        “artist1”: battle.challenger1Artist,
        “artist2”: battle.challenger2Artist,
        “numsongs”: battle.numberOfRounds + 15
      ]
      request.httpBody = try? JSONSerialization.data(withJSONObject: requestBody)
      let task = URLSession.shared.dataTask(with: request) { data, _, _ in
        guard let data = data else { return }
        let songs = try? JSONDecoder( ).decode([[AISong]].self, from: data)
        completion(songs ?? [ ])
      }
      task.resume( )
    }
  }
  func getTriviaQuestions( ) async throws −> [TriviaQuestion] {
    let artist1 = musicBattle?.challenger1Artist ?? “Artist1”
    let artist2 = musicBattle?.challenger2Artist ?? “Artist2”
    let numQuestions = musicBattle?.numberOfRounds ?? 5
    let topicFocus = “Both Artists”
    // Retrieve difficulty level from user preferences
    let difficultyLevel = getUserPreference(for: “triviaDifficultyLevel”) ?? “medium”
    // Generate a unique cache key
    let cacheKey = “\(artist1)−\(artist2)−\(numQuestions)−\(topicFocus)−\
(difficultyLevel)”
    // Check cache for existing questions
    if let cachedQuestions = retrieveCachedTriviaQuestions(key: cacheKey), !
cachedQuestions.isEmpty {
      return cachedQuestions
    }
    // Retrieve new trivia questions if not found in cache
    let triviaQuestions = try await fetchTriviaQuestions(
      artist1: artist1,
      artist2: artist2,
      numQuestions: numQuestions,
      topicFocus: topicFocus,
      difficultyLevel: difficultyLevel
    )
    // Cache the new questions
    cacheTriviaQuestions(questions: triviaQuestions, key: cacheKey)
    return triviaQuestions
  }
  func fetchTriviaQuestions(
    artist1: String,
    artist2: String,
    numQuestions: Int,
    topicFocus: String,
    difficultyLevel: String
  ) async throws −> [TriviaQuestion] {
    return try await withCheckedThrowingContinuation { continuation in
      sendTriviaRequest(
        artist1: artist1,
        artist2: artist2,
        numQuestions: numQuestions,
        topicFocus: topicFocus,
        difficultyLevel: difficultyLevel
      ) { result in
        switch result {
        case .success(let triviaQuestionsData):
          let triviaQuestions = triviaQuestionsData.compactMap
{ TriviaQuestion(dictionary: $0) }
          continuation.resume(returning: triviaQuestions)
        case .failure(let error):
          continuation.resume(throwing: error)
        }
      }
    }
  }
  func sendTriviaRequest(
    artist1: String,
    artist2: String,
    numQuestions: Int,
    topicFocus: String,
    difficultyLevel: String,
    completion: @escaping (Result<[[String: Any]], Error>) −> Void
  ) {
    // Abstracted endpoint and request details
    let endpoint = “TRIVIA_API_ENDPOINT”
    var requestBody: [String: Any] = [
      “artist1”: artist1,
      “artist2”: artist2,
      “numQuestions”: numQuestions,
      “topicFocus”: topicFocus,
      “difficultyLevel”: difficultyLevel
    ]
    performNetworkRequest(to: endpoint, with: requestBody) { result in
      switch result {
      case .success(let responseData):
        if let triviaQuestions = parseTriviaQuestions(from: responseData) {
          completion(.success(triviaQuestions))
        } else {
          completion(.failure(NSError(domain: “TriviaErrorDomain”, code: 1001,
userInfo: [NSLocalizedDescriptionKey: “Failed to parse trivia questions”])))
        }
      case .failure(let error):
        completion(.failure(error))
      }
    }
  }
  // Helper function to handle the network request
  func performNetworkRequest(
    to endpoint: String,
    with body: [String: Any],
    completion: @escaping (Result<[String: Any], Error>) −> Void
  ) {
    // Implementation of network request, abstracted for clarity
    print(“Sending request to \(endpoint) with body: \(body)”)
    // Simulated response for abstraction
    let simulatedResponse: [String: Any] = [
      “triviaQuestions”: [
        [“question”: “Who is the artist of song X?”, “answer”: “Artist1”],
        [“question”: “What year was album Y released?”, “answer”: “1985”]
      ]
    ]
    completion(.success(simulatedResponse))
  }
  // Helper function to parse trivia questions from response data
  func parseTriviaQuestions(from data: [String: Any]) −> [[String: Any]]? {
    return data[“triviaQuestions”] as? [[String: Any]]
  }
  // Abstracted user preferences retrieval
  func getUserPreference(for key: String) −> String? {
    // Simulated user preferences retrieval
    return “medium”
  }
  // Cache-related abstractions
  func retrieveCachedTriviaQuestions(key: String) −> [TriviaQuestion]? {
    // Simulated cache retrieval
    return nil
  }
  func cacheTriviaQuestions(questions: [TriviaQuestion], key: String) {
    // Simulated caching logic
    print(“Caching questions for key: \(key)”)
  }
```

### DETAILED DESCRIPTION OF FIGURES

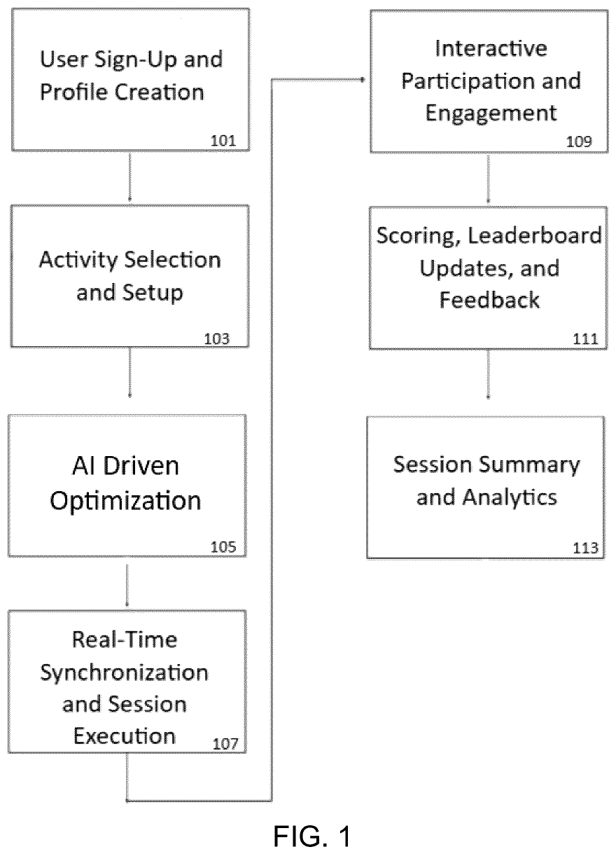

FIG. 1.101: User Sign-Up and Profile Creation—The user begins by creating an account on the platform, providing necessary credentials such as an email address and password, and setting up their profile. This step also includes optional integration with third-party services like Apple Music to sync media libraries. The platform may incorporate biometric authentication, such as Face ID, for secure and seamless access.

FIG. 1.103: Activity Selection and Setup—From the main dashboard, users select the desired activity, such as a music battle, trivia session, or collaborative creative session. They proceed to configure the activity parameters, including selecting challengers, defining themes, and setting voting styles. For group-based activities, users invite participants through the Family Circle system, with options for real-time or asynchronous participation.

FIG. 1.105: AI-Driven Optimization—Once the activity is set up, the platform's AI engine analyzes user preferences, selected themes, and historical data to curate content. For music battles, it pairs songs based on attributes like tempo and mood, while for trivia sessions, it dynamically generates contextually relevant questions. This personalization ensures a tailored and engaging experience for all participants.

A machine learning categorization engine processes the user preference data using pre-trained models. It comprises an application-specific integrated circuit (ASIC) for an artificial neural network connected to the computer memory device, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein the array is configured to analyze said user data using machine learning algorithms trained on historical datasets regarding which songs users chose based on the user preference inputs, wherein the AI/ML categorization engine identifies songs for a particular user based on the output from the array trained on the historical datasets.

FIG. 1.107: Real-Time Synchronization and Session Execution—The platform utilizes a real-time synchronization module, such as SharePlay, to manage music playback, voting, and trivia interactions across all participants. Synchronized media playback ensures a seamless experience, while instantaneous updates to session states maintain engagement and continuity.

FIG. 1.109: Interactive Participation and Engagement—During the session, users actively engage through live voting on songs, responding to trivia questions, and participating in chat discussions. The interface supports simultaneous interactions, displaying real-time results and progress updates. The gamified elements, including leaderboards and point scoring, keep participants motivated and invested.

FIG. 1.111: Scoring, Leaderboard Updates, and Feedback—At the conclusion of the activity, the system aggregates results from user interactions, including votes, trivia answers, and overall participation. Scores are calculated and displayed on leaderboards, with detailed feedback provided to participants, highlighting their performance and engagement metrics. The leaderboard system is powered by Apple's Game Center, ensuring transparency about the use of external APIs.

FIG. 1.113: Session Summary and Analytics—A comprehensive session summary is generated, showcasing key highlights such as top-voted songs, correct trivia answers, and participant rankings. Advanced analytics—such as voting data, trivia results, or engagement metrics—are provided for users to review their performance, and optional AI-generated recommendations for future sessions are displayed to encourage continued participation.

What is claimed is:

1. A system for facilitating interactive and collaborative experiences through music-based activities, comprising:
a. A display device displaying a user interface and one or more input/output devices configured to enable users to initiate, participate in, and manage music battles, trivia challenges, and creative sessions;
b. An artificial intelligence (AI) engine for dynamically generating song pairings based on user preferences, session context, and activity history, wherein the artificial intelligence engine comprises an application-specific integrated circuit (ASIC) for an artificial neural network connected to the computer memory device, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein the array is configured to analyze said user data using machine learning algorithms trained on historical datasets containing which songs users chose based on the user preference inputs, wherein the AI/ML categorization engine identifies song pairings for a particular user based on the output from the array trained on the historical datasets;
c. A processor with a system bus connected to an audio output utilizing real-time frameworks to ensure synchronized music playback, voting, and interactions among participants;
d. A cloud-based computer memory device for storing user data, including profiles, playlists, voting history, and session details; and
e. A network connection configured for invitation-based social engagement allowing users to create private groups and limit participation to trusted individuals.

2. The system of claim 1, wherein the user interface comprises:
a. A dashboard displaying ongoing, upcoming, and past activities.
b. A setup screen for configuring battles, including selecting challengers, defining voting modes, and customizing session parameters.
c. A real-time overlay for enabling chat, trivia participation, and voting during active sessions.

3. The system of claim 1, wherein the AI engine is configured to:
a. Analyze song attributes, including tempo, energy, and mood, to optimize song pairings.
b. Recommend battle themes tailored to user preferences, such as genres, decades, or artist-specific competitions.
c. Generate trivia questions dynamically, ensuring contextual relevance to the session.

4. The system of claim 1, further comprising integration with third-party media services to:
a. Access music libraries, metadata, and playlists.
b. Enable seamless media playback during battles and sessions.
c. Allow users to create and manage playlists within the platform.

5. The system of claim 1, wherein the synchronization module utilizes frameworks such as SharePlay to ensure:
a. Synchronized music playback across devices in real time.
b. Immediate updates to voting results and trivia scores during sessions.
c. Consistent session state management across all participants.

6. The system of claim 1, wherein the cloud-based infrastructure includes:
a. A database for securely storing user data, session history, and battle outcomes.
b. A serverless backend for handling data processing, AI requests, and voting calculations.
c. A notification system for providing real-time updates and reminders to participants.

7. The system of claim 1, wherein the invitation-based social engagement system comprises:
a. A Family Circle feature for creating private groups.
b. Integration with contact management services to facilitate invitations and group formation.
c. Access controls for limiting visibility and participation in activities to invited members.

8. A method for enabling collaborative music-based activities, comprising the steps of:
a. Receiving user input to initiate a music battle, trivia challenge, or creative session.
b. Analyzing user preferences and activity history using an AI engine to generate optimized content, including song pairings and trivia questions.
c. Synchronizing media playback, voting, and trivia participation across all devices using a real-time synchronization module.
d. Storing session details, user interactions, and results in a cloud-based infrastructure.
e. Delivering notifications and reminders to participants through an integrated scheduling and notification system.

9. The method of claim 8, further comprising the step of integrating with third-party APIs to access and manage media libraries, retrieve metadata, and enable seamless playback during sessions.

10. The method of claim 8, wherein the AI engine dynamically adapts session content in real time based on participant interactions, voting trends, and engagement levels.

11. The method of claim 8, wherein the synchronization module ensures:
a. Real-time updates to session states and scores.
b. Seamless transitions between activities.
c. Consistent user experiences across diverse network conditions.

12. The method of claim 8, further comprising the step of enabling participants to engage in private, invitation-only groups through a Family Circle system with controlled access.

13. The method of claim 8, wherein the platform supports both real-time and asynchronous participation modes to accommodate users across different time zones and schedules.

14. A computer-readable medium containing instructions that, when executed by a processor, perform the method of claim 8.

15. A system for gamified music education, comprising:
a. An AI-powered trivia generator for creating questions related to music theory, genres, and artist history.
b. A leaderboard for tracking user performance during trivia challenges and battles.
c. A user interface enabling educators to customize session content and monitor student progress.

16. The system of claim 15, wherein the AI engine recommends educational themes and materials based on user skill levels and engagement metrics.

17. The system of claim 15, further comprising an analytics module for providing detailed feedback on user performance, including correct trivia responses, voting trends, and session engagement.

18. The system of claim 1, wherein the user interface supports accessibility features such as simplified navigation for users of varying technical skill levels and adaptive interfaces for participants of different age groups.

19. The system of claim 1, further comprising integration with augmented reality (AR) or virtual reality (VR) technologies to create immersive music battles and trivia experiences.

20. The system of claim 1, wherein the platform provides AI-generated summaries of completed battles, including highlights, top-voted songs, and participant feedback.
